(19) United States
(12) Patent Application Publication
(10) Pub. No.: US 2009/0326114 A1
(43) Pub. Date: Dec. 31, 2009

(54) BARIUM SULFATE-CONTAINING COMPOSITE

(76) Inventors: Sonja Grothe, Bottrop (DE); Petra Fritzen, Duisburg (DE); Jochen Winkler, Rheurdt (DE); Bernd Rohe, Dinslaken (DE)

Correspondence Address: FULBRIGHT & JAWORSKI, LLP, 666 FIFTH AVE, NEW YORK, NY, 10103-3198, US

(21) Appl. No.: 12/438,609

(22) PCT Filed: Aug. 27, 2007
(86) PCT No.: PCT/EP2007/058893

§ 371 Date: May 28, 2009

(30) Foreign Application Priority Data
Aug. 25, 2006 (DE) 102006039855.6

(51) Int. Cl. C08K 5/51; C08K 3/30; C08K 5/09; C08K 3/10; C08K 3/34; C08K 5/41

(52) U.S. Cl. 524/148; 524/423; 524/322; 524/410; 524/408; 524/413; 524/443; 524/156

(57) ABSTRACT

Barium sulfate-containing composites, to methods for producing them and methods of using of the composites, as well as components containing the composites.

The invention provides a barium-sulfate-containing composite, a method for its production and the use of this composite.

From the application of conventional fillers and pigments, also known as additives, in polymer systems it is known that the nature and strength of the interactions between the particles of the filler or pigment and the polymer matrix influence the properties of a composite. Through selective surface modification the interactions between the particles and the polymer matrix can be influenced and hence the properties of the filler and pigment system in a polymer matrix, hereinafter also referred to as a composite, can be modified. A conventional type of surface modification is the functionalisation of the particle surfaces using alkoxyalkylsilanes. The surface modification can serve to increase the compatibility of the particles with the matrix. Furthermore, a binding of the particles to the matrix can also be achieved through the appropriate choice of functional groups. The disadvantage of using conventional fillers is that owing to their particle size they scatter visible light intensely and so the transparency of the composite is markedly reduced. Moreover, the poor chemical resistance of conventional fillers such as calcium carbonate, for example, is a disadvantage for many applications.

A second possibility for improving the mechanical properties of polymer materials is the use of ultrafine particles. U.S. Pat. No. 6,667,360 discloses polymer composites containing 1 to 50 wt. % of nanoparticles having particle sizes from 1 to 100 nm. Metal oxides, metal sulfides, metal nitrides, metal carbides, metal fluorides and metal chlorides are suggested as nanoparticles, the surface of these particles being unmodified. Epoxides, polycarbonates, silicones, polyesters, polyethers, polyolefines, synthetic rubber, polyurethanes, polyamide, polystyrenes, polyphenylene oxides, polyketones and copolymers and blends thereof are cited as the polymer matrix. In comparison to the unfilled polymer, the composites disclosed in U.S. Pat. No. 6,667,360 are said to have improved mechanical properties, in particular tensile properties and scratch resistance values. A disadvantage of the disclosed ultrafine particles is that they often have a high Mohs' hardness and hence a high abrasivity. In addition, the refractive index of the materials described (for example titanium dioxide, n=2.7) is very high in comparison to the refractive index of the polymer materials. This leads to a comparatively intense light scattering and hence to a reduction in the transparency of the composites.

Barium sulfate (BaSO₄) represents a special case among typical pigments and fillers. Barium sulfate is chemically inert and does not react with typical polymers. With a Mohs' hardness of 3, barium sulfate is comparatively soft; the Mohs' hardness of titanium dioxide in the rutile modification, for example, is 6.5. The refractive index of barium sulfate is comparatively low, at n=1.64.

The patent application DE 102005025719 A1 discloses a method for incorporating de-agglomerated barium sulfate having an average particle size of less than 0.5 μm and coated with a dispersing agent, into plastics precursors, e.g. polyols. In this method a plastic is produced which includes a de-agglomerated barium sulfate containing a dispersing agent and a crystallisation inhibitor. WO 2007/039625 A1 describes the use of barium sulfate or calcium carbonate particles containing at least one organic component in transparent polymers. A general disadvantage of using organically coated, de-agglomerated barium sulfate particles lies in the fact that the organic components cannot be used universally. The use of crystallisation inhibitors is particularly disadvantageous, because they are already used in the production (precipitation) of barium sulfate particles. In this case the compatibility of the crystallisation inhibitor with the plastics precursors or plastics severely limits the possible applications of the product. In an extreme case this can mean that a new product has to be developed and produced for each plastic. A further disadvantage of the de-agglomerated barium sulfate particles described in the applications DE 102005025719 A1 and WO 2007/039625 A1 consists in the particle-size distribution of the secondary particles, which should have an average particle diameter of less than 2 μm, preferably <250 nm, particularly preferably <200 nm, most particularly preferably <130 nm, even more preferably <100 nm, in particular preferably <50 nm. Such fine secondary particle distributions lead to a strong dust tendency, which for reasons of safety at work is to be avoided, particularly with nanoscale particles.

A further disadvantage of the filler-modified composites described in the prior art is their inadequate mechanical properties for many applications.

The object of the present invention is to overcome the disadvantages of the prior art.

The object of the invention is in particular to provide a composite which has markedly improved values for flexural modulus, flexural strength, tensile modulus, tensile strength, crack toughness, fracture toughness, impact strength and wear rates in comparison to prior art composites.

Surprisingly the object was achieved with composites according to the invention having the features of the main claim. Preferred embodiments are characterised in the sub-claims.

Surprisingly the mechanical and tribological properties of polymer composites were greatly improved according to the invention even with the use of precipitated, non-surface-modified barium sulfate having crystallite sizes d₅₀ of less than 350 nm (measured by the Debye-Scherrer method). This is all the more surprising as the non-surface-modified barium sulfate particles cannot form a bond between the particles and matrix.

It is known that chemical or physical bonds between the additive and matrix also have a favourable effect on improving the mechanical and tribological properties of the composite. A special embodiment according to the invention therefore provides for the provision and use of barium sulfate particles which are capable of forming such bonds. Surface-modified barium sulfate particles according to the invention are provided to that end. However, the surface modification necessary for the selective adjustment of the bond between the particles and matrix is not performed until after production of the barium sulfate particles (e.g. precipitation in aqueous media), in an additional process step.

The advantage of the subsequent surface modification lies in the high flexibility that it allows. This procedure allows particle formation to take place in the usual way during precipitation of barium sulfate, which means that particle formation is not negatively influenced by co-precipitates. In addition, it is easier to control the particle size and morphology of the barium sulfate particles.

Precipitation of the barium sulfate for use according to the invention can be performed by any method known from the prior art. Barium sulfate produced in a precipitation reactor for the precipitation of nanoscale particles, in particular a reaction cell for ultra-fast mixing of multiple reactants, for example of aqueous solutions of barium hydroxide or barium sulfide or barium chloride and sodium sulfate or sulfuric acid, is preferably used according to the invention. According to the invention, after precipitation the barium sulfate is preferably in the form of a precipitated suspension.

The barium sulfate used according to the invention is washed and concentrated to prevent the accumulating waste water from being organically contaminated. The barium sulfate is now in the form of a concentrated barium sulfate suspension.

The concentrated barium sulfate suspension can be dried by spray-drying, freeze-drying and/or mill-drying. Depending on the drying method, a subsequent milting of the dried powder may be necessary. Milling can be performed by methods known per se.

Spray-dried barium sulfate powders are preferably used to produce the composites according to the invention. These have the advantage that the relatively coarse spray-dryer agglomerates form a low-dust and very free-flowing powder which also disperses surprisingly well.

The composite according to the invention contains a polymer matrix having 0.1 to 60 wt. % of precipitated barium sulfate particles, with average crystallite sizes d₅₀ of less than 350 nm (measured by the Debye-Scherrer method). The crystallite size d₅₀ is preferably less than 200 nm, particularly preferably 3 to 50 nm. According to the invention the barium sulfate particles can be both surface-modified and non-surface-modified.

The composites according to the invention can also contain components known per se to the person skilled in the art, for example mineral fillers, glass fibres, stabilisers, process additives (also known as protective systems, for example dispersing aids, release agents, antioxidants, anti-ozonants, etc.), pigments, flame retardants (e.g. aluminium hydroxide, antimony trioxide, magnesium hydroxide, etc.), vulcanisation accelerators, vulcanisation retarders, zinc oxide, stearic acid, sulfur, peroxide and/or plasticisers.

A composite according to the invention can for example additionally contain up to 80 wt. %, preferably 10 to 80 wt. %, of mineral fillers and/or glass fibres, up to 10 wt. %, preferably 0.05 to 10 wt. %, of stabilisers and process additives (e.g. dispersing aids, release agents, antioxidants, etc.), up to 10 wt. % of pigment and up to 40 wt. % of flame retardant (e.g. aluminium hydroxide, antimony trioxide, magnesium hydroxide, etc.).

A composite according to the invention can be cited by way of example wherein the composite contains 100 phr of elastomer, 0.1 to 300 phr of barium sulfate, 0 to 10 phr of vulcanisation accelerator, 0 to 10 phr of vulcanisation retarder, 0 to 20 phr of zinc oxide, 0 to 10 phr of stearic acid, 0 to 20 phr of sulfur and/or peroxide, 0 to 300 phr of mineral filler, 0 to 200 phr of plasticiser, 0 to 30 phr of protective systems, preferably containing antioxidants and anti-ozonants.

According to the invention the polymer matrix can consist of an elastomer or a thermoset. Examples of elastomers are natural rubber (NR), isoprene rubber (IR), butyl rubber (CIIR, BIIR), butadiene rubber (BR), styrene-butadiene rubber (SBR), acrylonitrile-butadiene rubber (NBR), bromobutyl rubber (BIIR), styrene-butadiene-isoprene rubber (SBIR), chloroprene rubber (CR), chlorosulfonated polyethylene rubber (CSM), hydrogenated NBR rubber (HNBR), polymethylsiloxane-vinyl rubber (VMQ), acrylate-ethylene rubber (AEM), acrylate rubber (ACM), fluoro rubber (FKM), fluorosilicone rubber (FVMQ), thermoplastic elastomers (TPE), thermoplastic elastomers (TPE) based on polyamide (TPA), based on copolyesters (TPC), based on olefins (TPO), based on styrene (TPS), based on polyurethane (TPU), based on vulcanised rubber (TPV) or mixtures of at least two of these plastics. Suitable thermosets are, for example, unsaturated polyester resins (UP), phenolic resins, melamine resins, formaldehyde moulding compositions, vinyl ester resins, diallyl phthalate resins, silicone resins or urea resins. UP resins are particularly suitable thermosets.

Ultrafine barium sulfate particles without surface modification can be used according to the invention. Alternatively, in a particular embodiment, the barium sulfate particles can have an inorganic and/or organic surface modification.

The inorganic surface modification of the ultrafine barium sulfate typically consists of at least one inorganic compound selected from aluminium, antimony, barium, calcium, cerium, chlorine, cobalt, iron, phosphorus, carbon, manganese, oxygen, sulfur, silicon, nitrogen, strontium, vanadium, zinc, tin and/or zirconium compounds or salts. Sodium silicate, sodium aluminate and aluminium sulfate are cited by way of example.

The inorganic surface treatment of the ultrafine BaSO₄ takes place in an aqueous slurry. The reaction temperature should preferably not exceed 50° C. The pH of the suspension is set to pH values in the range above 9, using NaOH for example. The post-treatment chemicals (inorganic compounds), preferably water-soluble inorganic compounds such as, for example, aluminium, antimony, barium, calcium, cerium, chlorine, cobalt, iron, phosphorus, carbon, manganese, oxygen, sulfur, silicon, nitrogen, strontium, vanadium, zinc, tin and/or zirconium compounds or salts, are then added whilst stirring vigorously. The pH and the amounts of post-treatment chemicals are chosen according to the invention so that the latter are completely dissolved in water. The suspension is stirred intensively so that the post-treatment chemicals are homogeneously distributed in the suspension, preferably for at least 5 minutes. In the next step the pH of the suspension is lowered. It has proved advantageous to lower the pH slowly whilst stirring vigorously. The pH is particularly advantageously lowered to values from 5 to 8 within 10 to 90 minutes. This is followed according to the invention by a maturing period, preferably a maturing period of approximately one hour. The temperatures should preferably not exceed 50° C. The aqueous suspension is then washed and dried. Possible methods for drying ultrafine, surface-modified BaSO₄ include spray-drying, freeze-drying and/or mill-drying, for example. Depending on the drying method, a subsequent milling of the dried powder may be necessary. Milling can be performed by methods known per se.

To produce silanised, ultrafine, surface-modified BaSO₄ particles, an aqueous BaSO₄ suspension consisting of already inorganically surface-modified BaSO₄ particles is additionally modified with at least one silane. Alkoxyalkylsilanes are preferably used as silanes, the alkoxyalkylsilanes particularly preferably being selected from octyltriethoxysilane, gamma-methacrylopropyltrimethoxysi lane, gamma-glycidoxypropyltrimethoxysilane, gamma-aminopropyltriethoxysilane, gamma-aminopropyltrimethoxysilane, gamma-isocyanatopropyltriethoxysilane, vinyltrimethoxysilane and/or hydrolysed silanes, such as gamma-aminopropylsilsesquioxane (GE). To this end an alkoxyalkylsilane is added to a BaSO₄ suspension consisting of inorganically surface-modified BaSO₄ particles, before or after washing, whilst stirring vigorously or dispersing. This is followed according to the invention by a maturing time, preferably a maturing time of 10 to 60 minutes, preferably at temperatures of at most 40° C. The process then continues in the manner already described. Alternatively, the alkoxyalkylsilane can be applied to the inorganically modified particles after drying, by blending.

The following compounds are particularly suitable according to the invention as organic surface modifiers: polyethers, silanes, polysiloxanes, polycarboxylic acids, fatty acids, polyethylene glycols, polyesters, polyamides, polyalcohols, organic phosphonic acids, titanates, zirconates, alkyl and/or aryl sulfonates, alkyl and/or aryl sulfates, alkyl and/or aryl phosphoric acid esters.

Organically surface-modified barium sulfate can be produced by methods known per se. According to the invention a barium component is added to the barium sulfate suspension to produce a barium excess. Any water-soluble barium compound, for example barium sulfide, barium chloride and/or barium hydroxide, can be used as the barium component. The barium ions adsorb at the surfaces of the barium sulfate particles.

Then suitable organic compounds are added to this suspension whilst stirring vigorously and/or during a dispersion process. The organic compounds should be chosen so that they form a poorly soluble compound with barium ions. The addition of the organic compounds to the barium sulfate suspension causes the organic compounds to precipitate on the surface of the barium sulfate with the excess barium ions.

Suitable organic compounds are compounds selected from the group of alkyl and/or aryl sulfonates, alkyl and/or aryl sulfates, alkyl and/or aryl phosphoric acid esters or mixtures of at least two of these compounds, wherein the alkyl or aryl radicals can be substituted with functional groups. The organic compounds can also be fatty acids, optionally having functional groups. Mixtures of at least two such compounds can also be used.

The following can be used by way of example: alkyl sulfonic acid salt, sodium polyvinyl sulfonate, sodium-N-alkyl benzenesulfonate, sodium polystyrene sulfonate, sodium dodecyl benzenesulfonate, sodium lauryl sulfate, sodium cetyl sulfate, hydroxylamine sulfate, triethanol ammonium lauryl sulfate, phosphoric acid monoethyl monobenzyl ester, lithium perfluorooctane sulfonate, 12-bromo-1-dodecane sulfonic acid, sodium-10-hydroxy-1-decane sulfonate, sodium-carrageenan, sodium-10-mercapto-1-cetane sulfonate, sodium-16-cetene(1) sulfate, oleyl cetyl alcohol sulfate, oleic acid sulfate, 9,10-dihydroxystearic acid, isostearic acid, stearic acid, oleic acid.

The organically modified barium sulfate can either be used directly in the form of the aqueous paste or can be dried before use. Drying can be performed by methods known per se. Suitable drying options are in particular the use of convection-dryers, spray-dryers, mill-dryers, freeze-dryers and/or pulse-dryers. Other dryers can also be used according to the invention, however. Depending on the drying method, a subsequent milling of the dried powder may be necessary. Milling can be performed by methods known per se. The organically modified barium sulfate preferably has an average particle diameter of d₅₀=1 nm to 100 μm, preferably d₅₀=1 nm to 1 μm, particularly preferably d₅₀=5 nm to 0.5 μm, and prior to organic modification it is preferably dispersed to the primary particle size.

The primary particles have a logarithmic particle size distribution with a median of d=1 to 5000 nm, preferably d=1 to 1000 nm, particularly preferably d=5 to 500 nm, with a geometric standard deviation of σ_{g}<1.5, preferably σ_{g}<1.4.

Following the organic modification the organically modified barium sulfate can be additionally post-treated with functional silane derivatives or functional siloxanes. The following can be used by way of example: octyltriethoxysilane, methyltriethoxysilane, γ-methacryloxypropyltrimethoxysilane, γ-glycidyloxypropyltrimethoxysilane, γ-aminopropyltriethoxysilane, γ-isocyanatopropyltriethoxysilane, vinyltrimethoxysilane.

According to the invention the organically surface-modified barium sulfate particles optionally have one or more functional groups, for example one or more hydroxyl, amino, carboxyl, epoxy, vinyl, methacrylate and/or isocyanate groups, thiols, alkyl thiocarboxylates, di- and/or polysulfide groups.

The surface modifiers can be chemically and/or physically bound to the particle surface. The chemical bond can be covalent or ionic. Dipole-dipole or van der Waals bonds are possible as physical bonds. The surface modifiers are preferably bound by means of covalent bonds or physical dipole-dipole bonds.

According to the invention the surface-modified barium sulfate particles have the ability to form a partial or complete chemical and/or physical bond with the polymer matrix via the surface modifiers. Covalent and ionic bonds are suitable as chemical bond types. Dipole-dipole and van der Waals bonds are suitable as physical bond types.

In order to produce the composite according to the invention a masterbatch can preferably be produced first, which preferably contains 5 to 80 wt. % of barium sulfate. This masterbatch can then either be diluted with the crude polymer only or mixed with the other constituents of the formulation and optionally dispersed again.

In order to produce the composite according to the invention a method can also be chosen in which the barium sulfate is first incorporated into organic substances, in particular into amines, polyols, styrenes, formaldehydes and moulding compositions thereof, vinyl ester resins, polyester resins or silicone resins, and dispersed. These organic substances with added barium sulfate can then be used as the starting material for production of the composite.

Conventional dispersing methods, in particular using melt extruders, high-speed mixers, triple roll mills, ball mills, bead mills, submills, ultrasound or kneaders, can be used to disperse the barium sulfate in the masterbatch or in an organic substance. The use of submills or bead mills with bead diameters of d<1.5 mm is particularly advantageous.

The composite according to the invention surprisingly has outstanding mechanical and tribological properties. In comparison to the unfilled polymer the composite according to the invention has markedly improved values for flexural modulus, flexural strength, tensile modulus, tensile strength, crack toughness, fracture toughness, impact strength and wear rates.

Improved mechanical properties allow thinner components to be produced. This can make a decisive contribution to reducing weight in the automotive and aerospace sector. Applications include, for example, bumpers or interior trim in trains and aircraft made from thermoset moulding compositions. Adhesives require high tensile strength values above all. Applications for elastomeric plastics, based for example on polymers such as styrene-butadiene rubber (SBR), include inter alia seals and vibration dampers.

The invention provides in detail:
Composites consisting of at least one elastomer and/or at least one thermoset and barium sulfate, whose crystallite size d₅₀ is less than 350 nm, preferably less than 200 nm and particularly preferably between 3 and 50 nm, and wherein the barium sulfate can be both inorganically or organically surface-modified and also non-surface-modified (hereinafter also referred to as barium sulfate composites);
Barium sulfate composites, wherein at least one unsaturated polyester resin (UP), phenolic resin, melamine resin, formaldehyde moulding composition, vinyl ester resin, diallyl phthalate resin, silicone resin and/or urea resin, preferably a UP resin, is used as the thermoset;
Barium sulfate composites, wherein as the elastomer at least one elastomer from the following is selected: natural rubber (NR), isoprene rubber (IR), butyl rubber (CIIR, BIIR), butadiene rubber (BR), styrene-butadiene rubber (SBR), acrylonitrile-butadiene rubber (NBR), bromobutyl rubber (BIIR), styrene-butadiene-isoprene rubber (SBIR), chloroprene rubber (CR), chlorosulfonated polyethylene rubber (CSM), hydrogenated NBR rubber (HNBR), polymethylsiloxane-vinyl rubber (VMQ), acrylate-ethylene rubber (AEM), acrylate rubber (ACM), fluoro rubber (FKM), fluorosilicone rubber (FVMQ), thermoplastic elastomers (TPE), thermoplastic elastomers (TPE) based on polyamide (TPA), based on copolyesters (TPC), based on olefins (TPO), based on styrene (TPS), based on polyurethane (TPU), based on vulcanised rubber (TPV), or wherein mixtures of at least two of these elastomers are used as the elastomer;
Barium sulfate composites, wherein the composite contains 20 to 99.8 wt. % of thermoset, 0.1 to 60 wt. % of barium sulfate, 0 to 80 wt. % of mineral filler and/or glass fibre, 0.05 to 10 wt. % of process additives, 0 to 10 wt. % of pigment and 0 to 40 wt. % of aluminium hydroxide;
   Barium sulfate composites, wherein the composite contains 100 phr of elastomer, 0.1 to 300 phr of barium sulfate, 0 to 10 phr of vulcanisation accelerator, 0 to 10 phr of vulcanisation retarder, 0 to 20 phr of zinc oxide, 0 to 10 phr of stearic acid, 0 to 20 phr of sulfur and/or peroxide, 0 to 300 phr of mineral filler, 0 to 200 phr of plasticiser, 0 to 30 phr of protective systems, preferably containing antioxidants and anti-ozonants;
Barium sulfate composites, wherein the proportion of barium sulfate in the composite is 0.1 to 60 wt. %, preferably 0.5 to 30 wt. %, particularly preferably 1.0 to 20 wt. %;
Method for producing the barium sulfate composite;
Method for producing the barium sulfate composite, wherein a masterbatch is produced first and the barium sulfate composite is obtained by diluting the masterbatch with the crude polymer, the masterbatch containing 5 to 80 wt. % of barium sulfate, preferably 15 to 60 wt. % of barium sulfate;
Method for producing the barium sulfate composite, wherein a masterbatch is produced first and the barium sulfate composite is obtained by diluting the masterbatch with the crude polymer and dispersing it;
Method for producing the barium sulfate composite, wherein the masterbatch is mixed with the other constituents of the formulation in one or more steps and a dispersion preferably follows;
Method for producing the barium sulfate composite, wherein the barium sulfate is first incorporated into organic substances, in particular into amines, polyols, styrenes, formaldehydes and moulding compositions thereof, vinyl ester resins, polyester resins or silicone resins, and dispersed, wherein the barium sulfate can be both inorganically or organically surface-modified and also non-surface-modified;
Method for producing the barium sulfate composite, wherein the organic substances with added barium sulfate are used as the starting material for production of the composite;
Method for producing the barium sulfate composite, wherein dispersion of the barium sulfate in the masterbatch or in an organic substance is performed using conventional dispersing methods, in particular using melt extruders, high-speed mixers, triple roll mills, ball mills, bead mills, submills, ultrasound or kneaders;
Method for producing the barium sulfate composite, wherein submills or bead mils are preferably used to disperse the barium sulfate;
Method for producing the barium sulfate composite, wherein bead mills are preferably used to disperse the barium sulfate, the beads preferably having diameters of d<1.5 mm, particularly preferably d<1.0 mm, most particularly preferably d<0.3 mm;
Barium sulfate composite having improved mechanical properties and improved tribological properties;
Barium sulfate composite, wherein the improvement in the strength and toughness can be observed in a flexural test or a tensile test;
Barium sulfate composite having improved impact strength and/or improved notched impact strength values;
Barium sulfate composite having improved wear resistance;
Barium sulfate composite having improved scratch resistance;
Barium sulfate composite having improved stress cracking resistance;
Barium sulfate composite, wherein an improvement in the creep resistance can be observed;
Barium sulfate composite, wherein the viscoelastic properties, characterised by the loss factor tan δ, are improved;
Use of the barium sulfate composite for components for the automotive or aerospace sector, in particular for the purposes of weight reduction, for example in the form of bumpers or interior trim;
Use of the barium sulfate composite, in particular in the form of seals or vibration dampers.

The invention is illustrated by means of the examples below, without being limited thereto.

### EXAMPLE 1

A precipitated, unmodified barium sulfate having a crystallite size d₅₀ of 26 nm is used as the starting material. The non-surface-modified barium sulfate is dispersed in the UP resin Palapreg P17-02 in a concentration of 25 wt. % using a bead mill until the fineness measured on a Hegmann gauge is less than 5 μm.

TABLE 1
Formulation for glass-fibre-reinforced plastics based on UP resin

| | | | | Material |
|---|---|---|---|---|
| | | | | weight |
| Reactant | Manufacturer | | | [g] |
| Palapreg P17-02* | BASF | 70% | | 31.08* |
| Palapreg H814-01 | DSM Composite Resins | 30% | | 13.32 |
| BYK W996 | BYK-Chemie GmbH | 1.5 | phr | 0.67 |
| BYK P9060 | BYK-Chemie GmbH | 4 | phr | 1.78 |
| Trigonox C | Akzo Nobel | 1.5 | phr | 0.67 |
| Coathylene HA 1681 | Du Pont Polymer Powders | 1.5 | phr | 0.67 |
| Luvatol MV 35 NV | Lehmann & Voss & Co | 3 | phr | 1.33 |
| Millicarb OG | Omya GmbH | 50 | phr | 22.20 |
| Martinal ON 921 | Martinswerk GmbH | 120 | phr | 53.29 |

| | | | |
|---|---|---|---|
| Barium sulfate* | Sachtleben Chemie GmbH | 2% | 2.59* |
| Glass fibres | Saint-Gobain Vetrolex | 25% | 33.84 |

*as a ready-to-use dispersion after bead grinding, weighed as a total weight of 33.67 g (Palapreg P17-02 + barium sulfate)

This dispersion based on the material weights specified in Table 1 is stirred with the additional resin Palapreg H814-01 and the additives in a high-speed mixer (mixer disc: diameter 30 mm) at 1500 rpm in a 180 ml plastic beaker and the necessary amount of fillers is added slowly whilst increasing the speed. On completion of the addition of fillers, the mixture is dispersed for 3 minutes at 6500 rpm.

The necessary amount of glass fibres is added to the crude composition and folded in with the aid of a spatula. This mixture is homogenised in a kneader for a further 3 minutes at 50 rpm. The resulting composition is carefully spread into a mould, which is impregnated with release agent and has 12 recesses measuring 80 mm×15 mm×4 mm, and the surface is smoothed. The lower press platen of the mould is a Teflon plate, the upper press platen is a polished, chrome-plated metal plate. The plates together with the protective paper are introduced into the press, which has been pre-heated to 150° C., and heated for one minute at 150° C. (with the press closed under normal pressure) and then the plates are press-moulded under a pressure of 100 bar at 150° C. After press-moulding the plates are left to cool and the specimens are pushed out of the mould.

The specimens are examined in 3-point bending tests as defined in DIN EN ISO 178 and in impact strength tests as defined in DIN EN ISO 179. The results are set out in Table 2.

The composites according to the invention exhibit greatly improved properties in comparison to the pure resin.

TABLE 2
Mechanical properties of the prepared specimens

| | | Max. | | Rel. | |
|---|---|---|---|---|---|
| | Elastic | flexural | Breaking | elongation | Impact |
| | modulus | stress | stress | at break | strength |
| Sample | [MPa] | [MPa] | [MPa] | [%] | [kJ/m²] |
| Composite | 11759 | 66.51 | 39.66 | 0.84 | 8.77 |
| without barium | | | | | |
| sulfate | | | | | |
| Composite with | 11804 | 86.04 | 58.69 | 1.05 | 12.01 |
| 2% barium sulfate | | | | | |

### EXAMPLE 2

A surface-modified barium sulfate having a crystallite size d₅₀ of 26 nm is used as the starting material. The barium sulfate surface is post-treated inorganically and silanised. The inorganic surface modification consists of a silicon-aluminium-oxygen compound. 3-Methacryloxypropyltrimethoxysilane is used for silanisation.

The inorganically surface-modified barium sulfate can be produced by the following method, for example:

3.7 kg of a 6.5 wt. % aqueous suspension of ultrafine BaSO₄ particles having average primary particle diameters d₅₀ of 26 nm (result of TEM analyses) are heated to a temperature of 40° C. whilst stirring. The pH of the suspension is adjusted to 12 using 10% sodium hydroxide solution. 14.7 ml of an aqueous sodium silicate solution (284 g SiO₂/l), 51.9 ml of an aluminium sulfate solution (with 75 g Al₂O₃/l) and 9.7 ml of a sodium aluminate solution (275 g Al₂O₃/l) are added simultaneously to the suspension whilst stirring vigorously and keeping the pH at 12.0. The suspension is homogenised for a further 10 minutes whilst stirring vigorously. The pH is then slowly adjusted to 7.5, preferably within 60 minutes, by adding a 5% sulfuric acid. This is followed by a maturing time of 10 minutes, likewise at a temperature of 40° C. The suspension is then washed to a conductivity of less than 100 μS/cm and then spray-dried. The washed suspension is adjusted with demineralised water to a solids content of 20 wt. % and dispersed for 15 minutes using a high-speed mixer. 15 g of 3-methacryloxypropyltrimethoxysilane are added slowly to the suspension whilst dispersing with the high-speed mixer. The suspension is then dispersed with the high-speed mixer for a further 20 minutes and then dried in a freeze-dryer.

The surface-modified barium sulfate is dispersed in the UP resin Palapreg P17-02 in a concentration of 25 wt. % using a bead mill until the fineness measured on a Hegmann gauge is less than 5 μm.

TABLE 3
Formulation for glass-fibre-reinforced plastics based on UP resin

| | | | | Material |
|---|---|---|---|---|
| | | | | weight |
| Reactant | Manufacturer | | | [g] |
| Palapreg P17-02* | BASF | 70% | | 31.08* |
| Palapreg H814-01 | DSM Composite Resins | 30% | | 13.32 |
| BYK W996 | BYK-Chemie GmbH | 1.5 | phr | 0.67 |
| BYK P9060 | BYK-Chemie GmbH | 4 | phr | 1.78 |
| Trigonox C | Akzo Nobel | 1.5 | phr | 0.67 |
| Coathylene HA 1681 | Du Pont Polymer Powders | 1.5 | phr | 0.67 |
| Luvatol MV 35 NV | Lehmann & Voss & Co | 3 | phr | 1.33 |
| Millicarb OG | Omya GmbH | 50 | phr | 22.20 |
| Martinal ON 921 | Martinswerk GmbH | 120 | phr | 53.29 |

| | | | |
|---|---|---|---|
| Barium sulfate, | Sachtleben Chemie GmbH | 2% | 2.59* |
| surface-modified* | | | |
| Glass fibres | Saint-Gobain Vetrolex | 25% | 33.84 |

*as a ready-to-use dispersion after bead grinding, weighed as a total weight of 33.67 g (Palapreg P17-02 + barium sulfate)

This dispersion based on the material weights specified in Table 3 is stirred with the additional resin Palapreg H814-01 and the additives in a high-speed mixer (mixer disc: diameter 30 mm) at 1500 rpm in a 180 ml plastic beaker and the necessary amount of fillers is added slowly whilst increasing the speed. On completion of the addition of fillers, the mixture is dispersed for 3 minutes at 6500 rpm.

The necessary amount of glass fibres is added to the crude composition and folded in with the aid of a spatula. This mixture is homogenised in a kneader for a further 3 minutes at 50 rpm. The resulting composition is carefully spread into a mould, which is impregnated with release agent and has 12 recesses measuring 80 mm×15 mm×4 mm, and the surface is smoothed. The lower press platen of the mould is a Teflon plate, the upper press platen is a polished, chrome-plated metal plate. The plates together with the protective paper are introduced into the press, which has been pre-heated to 150° C., and heated for one minute at 150° C. (with the press closed under normal pressure) and then the plates are press-moulded under a pressure of 100 bar at 150° C. After press-moulding the plates are left to cool and the specimens are pushed out of the mould.

The specimens are examined in 3-point bending tests as defined in DIN EN ISO 178 and in impact strength tests as defined in DIN EN ISO 179. The results are set out in Table 4.

The composites according to the invention exhibit greatly improved properties in comparison to the pure resin.

TABLE 4
Mechanical properties of the prepared specimens

| | | Max. | | Rel. | |
|---|---|---|---|---|---|
| | Elastic | flexural | Breaking | elongation at | Impact |
| | modulus | stress | stress | break | strength |
| Sample | [MPa] | [MPa] | [MPa] | [%] | [kJ/m²] |
| Composite | 11759 | 66.51 | 39.66 | 0.84 | 8.77 |
| without barium | | | | | |
| sulfate | | | | | |
| Composite with | 12310 | 90.23 | 60.28 | 1.12 | 13.14 |
| 2% silanised | | | | | |
| barium sulfate | | | | | |

### EXAMPLE 3

An organically surface-modified barium sulfate having a crystallite size d₅₀ of 20 nm is used as the starting material. An oleyl cetyl alcohol sulfate sodium salt having acrylate functionality was used as the organic surface modification.

The organically surface-modified barium sulfate can be produced by the following method, for example:

500 g of barium sulfate are suspended in 0.5 l of deionised water at room temperature in a mixing vessel. A barium excess is then established using a 0.1 molar barium hydroxide solution so that a pH of 11 is obtained. 25 g of oleyl cetyl alcohol sulfate sodium salt having acrylate functionality are slowly introduced into the barium sulfate suspension whilst stirring vigorously. The suspension is then stirred for a further 30 min. The pH is then slowly adjusted to 6.0 using 0.1-molar sulfuric acid and the mixture is stirred for a further 15 min. The precipitated product is and then dried at 105° C.

The organically surface-modified barium sulfate is dispersed in the UP resin Palapreg P17-02 in a concentration of 25 wt. % using a bead mill until the fineness measured on a Hegmann gauge is less than 5 μm.

TABLE 5
Formulation for glass-fibre-reinforced plastics based on UP resin

| | | | | Material |
|---|---|---|---|---|
| | | | | weight |
| Reactant | Manufacturer | | | [g] |
| Palapreg P17-02* | BASF | 70% | | 31.08* |
| Palapreg H814-01 | DSM Composite Resins | 30% | | 13.32 |
| BYK W996 | BYK-Chemie GmbH | 1.5 | phr | 0.67 |
| BYK P9060 | BYK-Chemie GmbH | 4 | phr | 1.78 |
| Trigonox C | Akzo Nobel | 1.5 | phr | 0.67 |
| Coathylene HA 1681 | Du Pont Polymer Powders | 1.5 | phr | 0.67 |
| Luvatol MV 35 NV | Lehmann & Voss & Co | 3 | phr | 1.33 |
| Millicarb OG | Omya GmbH | 50 | phr | 22.20 |
| Martinal ON 921 | Martinswerk GmbH | 120 | phr | 53.29 |

| | | | |
|---|---|---|---|
| Barium sulfate, | Sachtleben Chemie GmbH | 2% | 2.59* |
| surface-modified* | | | |
| Glass fibres | Saint-Gobain Vetrolex | 25% | 33.84 |

*as a ready-to-use dispersion after bead grinding, weighed as a total weight of 33.67 g (Palapreg P17-02 + barium sulfate)

This dispersion based on the material weights specified in Table 5 is stirred with the additional resin Palapreg H81401 and the additives in a high-speed mixer (mixer disc: diameter 30 mm) at 1500 rpm in a 180 ml plastic beaker and the necessary amount of fillers is added slowly whilst increasing the speed. On completion of the addition of fillers, the mixture is dispersed for 3 minutes at 6500 rpm.

The necessary amount of glass fibres is added to the crude composition and folded in with the aid of a spatula. This mixture is homogenised in a kneader for a further 3 minutes at 50 rpm. The resulting composition is carefully spread into a mould, which is impregnated with release agent and has 12 recesses measuring 80 mm×15 mm×4 mm, and the surface is smoothed. The lower press platen of the mould is a Teflon plate, the upper press platen is a polished, chrome-plated metal plate. The plates together with the protective paper are introduced into the press, which has been pre-heated to 150° C., and heated for one minute at 150° C. (with the press closed under normal pressure) and then the plates are press-moulded under a pressure of 100 bar at 150° C. After press-moulding the plates are left to cool and the specimens are pushed out of the mould.

The specimens are examined in 3-point bending tests as defined in DIN EN ISO 178 and in impact strength tests as defined in DIN EN ISO 179. The results are set out in Table 6.

The composites according to the invention exhibit greatly improved properties in comparison to the pure resin.

TABLE 6
Mechanical properties of the prepared specimens

| | | Max. | | Rel. | |
|---|---|---|---|---|---|
| | Elastic | flexural | Breaking | elongation | Impact |
| | modulus | stress | stress | at break | strength |
| Sample | [MPa] | [MPa] | [MPa] | [%] | [kJ/m²] |
| Composite | 11759 | 66.51 | 39.66 | 0.84 | 8.77 |
| without barium | | | | | |
| sulfate | | | | | |
| Composite with | 12354 | 88.26 | 59.73 | 1.09 | 12.87 |
| 2% organically | | | | | |
| surface-modified | | | | | |
| barium sulfate | | | | | |

1-29. (canceled)

30. A composite comprising a filler and a pigment in a polymer matrix, wherein the composite contains barium sulfate having a crystallite size, and at least one of an elastomer or a thermoset, wherein the crystallite size of the barium sulfate d₅₀ is less than 350 nm, and wherein the barium sulfate can be inorganically surface modified, organically surface-modified or non-surface-modified.

31. A composite according to claim 30, wherein the thermoset comprises at least one of an unsaturated polyester resin, a phenolic resin, a melamine resin, a formaldehyde molding composition, a vinyl ester resin, a diallyl phthalate resin, a silicone resin or an urea resin.

32. A composite according to claim 30, wherein the elastomer comprises at least one member selected from the group consisting of natural rubber, isoprene rubber, butyl rubber, butadiene rubber, styrene-butadiene rubber, acrylonitrile-butadiene rubber, bromobutyl rubber, styrene-butadiene-isoprene rubber, chloroprene rubber, chlorosulfonated polyethylene rubber, hydrogenated acrylonitrile-butadiene rubber, polymethylsiloxane-vinyl rubber, acrylate-ethylene rubber, acrylate rubber, fluoro rubber, fluorosilicone rubber, a thermoplastic elastomer, a thermoplastic elastomer based on polyamide, a thermoplastic elastomer based on a copolyester, a thermoplastic elastomer based on an olefin, a thermoplastic elastomer based on styrene, a thermoplastic elastomer based on polyurethane and a thermoplastic elastomer based on vulcanized rubber.

33. A composite according to claim 30, wherein the composite contains 20 to 99.8 wt. % of the thermoset, 0.1 to 60 wt. % of the barium sulfate, 0 to 80 wt. % of mineral filler or glass fiber, 0.05 to 10 wt. % of a process additive, 0 to 10 wt. % of a pigment and 0 to 40 wt. % of aluminum hydroxide.

34. A composite according to claim 30, wherein the composite contains 100 phr of the elastomer, 0.1 to 300 phr of the barium sulfate, 0 to 10 phr of a vulcanization accelerator, 0 to 10 phr of a vulcanization retarder, 0 to 20 phr of zinc oxide, 0 to 10 phr of stearic acid, 0 to 20 phr of sulfur or peroxide, 0 to 300 phr of mineral filler, 0 to 200 phr of a plasticizer and 0 to 30 phr of a protective system.

35. A composite according to claim 30, wherein the composite comprises 0.1 to 60 wt. % barium sulfate.

36. A composite according to claim 30, wherein the barium sulfate is surface-modified with at least one inorganic compound.

37. A composite according to claim 36, wherein the percentage by weight of inorganic compounds relative to BaSO₄ is 0.1 to 50.0 wt. %.

38. A composite according to claim 36, wherein the inorganic compound comprises at least one member selected from the group consisting of aluminum, antimony, barium, calcium, cerium, chlorine, cobalt, iron, phosphorus, carbon, manganese, oxygen, sulfur, silicon, nitrogen, strontium, vanadium, zinc, tin and zirconium, or a salt thereof.

39. A composite according to claim 36, wherein the BaSO₄ particles, in addition to the surface modification with inorganic compounds, are modified with at least one of a silane or a multiple silane.

40. A composite according to claim 39, wherein the silane is an alkoxyalkylsilanes.

41. A composite according to claim 40, wherein the alkoxyalkylsilane is selected from the group consisting of octyltriethoxysilane, gamma-methacrylopropyltrimethoxysilane, gamma-glycidoxypropyltrimethoxysilane, gamma-aminopropyltriethoxysilane, gamma-aminopropyltrimethoxysilane, gamma-isocyanatopropyltriethoxysilane, vinyltrimethoxysilane and a hydrolyzed silane.

42. A composite according to claim 30, wherein the BaSO₄ particles have a primary particle size d₅₀ of less than or equal to 0.1 μm.

43. A composite according to claim 30, wherein the barium sulfate is surface-modified with an organic compound.

44. A composite according to claim 43, wherein the organic compound is selected from the group consisting of an alkyl sulfonate, an aryl sulfonate, an alkyl sulfate, an aryl sulfate, an alkyl phosphoric acid ester, an aryl phosphoric acid ester, wherein alkyl or aryl radicals of the organic compound may optionally be substituted with a functional group or a fatty acid.

45. A composite according to claim 43, wherein the organic compound is at least one member selected from the group consisting of an alkyl sulfonic acid salt, sodium polyvinyl sulfonate, sodium-N-alkyl benzenesulfonate, sodium polystyrene sulfonate, sodium dodecyl benzenesulfonate, sodium lauryl sulfate, sodium cetyl sulfate, hydroxylamine sulfate, triethanol ammonium lauryl sulfate, phosphoric acid monoethyl monobenzyl ester, lithium perfluorooctane sulfonate, 12-bromo-1-dodecane sulfonic acid, sodium-10-hydroxy-1-decane sulfonate, sodium-carrageenan, sodium-10-mercapto-1-cetane sulfonate, sodium-16-cetene(1) sulfate, oleyl cetyl alcohol sulfate, oleic acid sulfate, 9,10-dihydroxystearic acid, isostearic acid, stearic acid and oleic acid.

46. A composite according to one claim 43, wherein the barium sulfate has an average particle diameter of d₅₀=1 mm to 100 μm.

47. A composite according to claim 43, wherein primary particles of the barium sulfate have a logarithmic particle size distribution with a median of d=1 to 5,000 nm and a logarithmic particle size distribution with a geometric standard deviation of σ_{g}<1.5.

48. A composite according to claim 43, wherein the barium sulfate is post-treated with at least one functional silane derivative or a functional siloxane from the group consisting of octyltriethoxysilanes, methyltriethoxysilanes, γ-methacryloxypropyltrimethoxysilanes, γ-glycidyloxypropyltrimethoxysilanes, γ-amiinopropyltriethoxysilanes, γ-isocyanatopropyltriethoxysilanes and vinyltrimethoxysilane.

49. A method for producing a composite according claim 30, wherein a masterbatch is produced from the barium sulfate and part of the crude polymer and the composite is obtained by diluting the masterbatch with the crude polymer and dispersing it.

50. A method according to claim 49, wherein a masterbatch is produced from the barium sulfate and part of the crude polymer and the composite is obtained by diluting the masterbatch with the crude polymer, wherein the masterbatch contains 5 to 80 wt. % of barium sulfate.

51. A method according to claim 49, wherein the masterbatch is mixed with the other constituents to form a dispersion.

52. A method according to claim 49, wherein the barium sulfate is first incorporated into an organic substance and dispersed therein.

53. A method according to claim 52, wherein the organic substance with the added barium sulfate form a starting material for production of the composite.

54. A method according to claim 43, wherein a dispersion of the barium sulfate in the masterbatch or in an organic substance is performed using a melt extruder, a high-speed mixer, a triple roll mill, a ball mill, a bead mill, a submill, an ultrasound or a kneader.

55. A method according to claim 54, wherein the dispersion of the barium sulfate is preferably performed in a submill or a bead mill.

56. A method according to claim 43, wherein dispersion of the barium sulfate is performed in a bead mill, wherein beads having diameters of d<1.5 mm are provided.

57. An automotive or aerospace part comprising the composite of claim 30.

58. A seal or vibration damper comprising the composite of claim 30.
